(19) United States
(12) Patent Application Publication
(10) Pub. No.: US 2019/0152273 A1
(43) Pub. Date: May 23, 2019

(54) PNEUMATIC TIRE

(71) Applicant: TOYO TIRE & RUBBER CO., LTD., Itami-shi (JP)

(72) Inventor: Harunobu Suita, Itami-shi (JP)

(73) Assignee: TOYO TIRE & RUBBER CO., LTD., Itami-shi (JP)

(21) Appl. No.: 16/176,610

(22) Filed: Oct. 31, 2018

(30) Foreign Application Priority Data
Nov. 22, 2017 (JP) 2017-225135

(51) Int. Cl. B60C 11/12

(52) U.S. Cl. CPC B60C 11/1236; B60C 2011/1254; B60C 11/1204

(57) ABSTRACT

The pneumatic tire includes a plurality of ribs formed by a plurality of main grooves extending in a tire circumferential direction and connected to each other in the tire circumferential direction. The shoulder rib positioned on either side in a tire width direction of the ribs includes a first sipe configured to open to a ground contact surface and an outer side surface on a rib end side, and a second sipe positioned on an inner side in a tire radial direction of the first sipe and configured to open to the outer side surface.

### CROSS-REFERENCE TO RELATED APPLICATIONS

This application claims priority based on Japanese Patent Application No. 2017-225135 filed on Nov. 22, 2017, the contents of which are incorporated herein by this reference.

### BACKGROUND OF THE INVENTION

### Technical Field

The present invention relates to a pneumatic tire.

### Related Art

Conventionally, pneumatic tires are known in which land portions are formed with a plurality of circumferential grooves extending in the tire circumferential direction and sipes not opened in the top portions of the land portions are formed in the side groove walls (see, for example, Japanese Unexamined Patent Application Publication No. 2010-105591).

However, in the conventional pneumatic tire, the sipe to be formed is arranged on the main groove side of the rib, makes it easy to deform the land portion when the top portion of the tire wears, and is used to utilize the rib formed in the groove only for braking.

### SUMMARY

An object of the present invention is to provide a pneumatic tire capable of improving uneven wear resistance of a shoulder rib.

As means for solving the above problems, the present invention provides a pneumatic tire including a plurality of ribs formed by a plurality of main grooves extending in a tire circumferential direction, the plurality of ribs connected to each other in the tire circumferential direction, wherein a shoulder rib positioned on either side in a tire width direction of the ribs includes: a first sipe configured to open to a ground contact surface and an outer side surface on a rib end side, and a second sipe positioned on an inner side in a tire radial direction of the first sipe, the second sipe configured to open to the outer side surface.

With this configuration, in the initial stage of wear of the shoulder ribs, making the rib end side easily deformed with the first sipe allows the ground contact pressure to be reduced and wear to be suppressed. In addition, in the middle and late stages of wear which the wear of the shoulder rib progresses, the second sipe can suppress the slippage on the rib end side of the shoulder rib. Therefore, it is possible to make the shoulder rib capable of suppressing uneven wear from the initial stage to the late stage of wear and excellent in uneven wear resistance.

The first sipe and the second sipe are preferably arranged at equal intervals in a tire circumferential direction.

With this configuration, the rigidity in the shoulder rib can be uniformly reduced in the tire circumferential direction.

The first sipe and the second sipe are preferably arranged to be displaced in a tire circumferential direction.

With this configuration, it is possible to prevent the rigidity on the rib end side in the shoulder rib in which each sipe is formed from being excessively lowered.

The first sipe preferably has a triangular shape in meridian section in which a bottom portion is inclined outward in a tire radial direction toward an inner side in a tire width direction.

With this configuration, it is possible to prevent occurrence of cracks due to too low rigidity in the thickness region where the first sipe is formed.

The second sipe preferably has a quadrangular shape in meridian section in which a bottom portion does not change a position in a tire radial direction toward an inner side in a tire width direction.

With this configuration, in the middle stage and the late stage of wear of the shoulder rib, the slippage in the circumferential direction on the rib end side can be suppressed, and the uneven wear resistance can be improved.

The first sipe is preferably provided in a range of 30% or less of a height dimension from the main groove of the shoulder rib from a top surface of the shoulder rib.

The second sipe is preferably provided in a range of 30% or more and 60% or less of a height dimension from the main groove of the shoulder rib from a top surface of the shoulder rib.

The bottom portion of the first sipe and a top portion of the second sipe preferably have a predetermined space in between in a tire radial direction.

With this configuration, it is possible to prevent the first sipe and the second sipe from simultaneously opening to the top surface side to extremely lower the rigidity.

According to the present invention, since the first sipe on the outer side in the tire radial direction and the second sipe on the inner side in the tire width direction are provided in the shoulder rib, in the initial stage of wear, the first sipe making the rib end side easily deformed and reducing the ground contact pressure at the rib end allows the occurrence of wear to be delayed. In addition, in the middle stage and the late stage of wear, the second sipe suppressing slippage in the circumferential direction allows the progress of wear to be delayed. This makes it possible to improve the wear resistance of the shoulder rib from the initial stage to the late stage of wear.

### BRIEF DESCRIPTION OF THE DRAWINGS

The foregoing and the other features of the present invention will become apparent from the following description and drawings of an illustrative embodiment of the invention in which:

FIG. 1 is a meridian sectional view showing a part of a pneumatic tire according to the present embodiment;

FIG. 2 is a partially enlarged view of FIG. 1;

FIG. 3 is a perspective view showing a part of a shoulder rib in FIG. 1; and

FIG. 4 is a side view of the shoulder rib in FIG. 3.

### DETAILED DESCRIPTION OF EMBODIMENTS

In the following, an embodiment according to the present invention will be described with reference to the accompanying drawings. It should be noted that the following description is, fundamentally, merely illustrative and is not intended to limit the present invention, products to which the present invention is applied, or applications of the present invention. In addition, the drawings are schematic, and the ratio and the like of each dimension are different from actual ones.

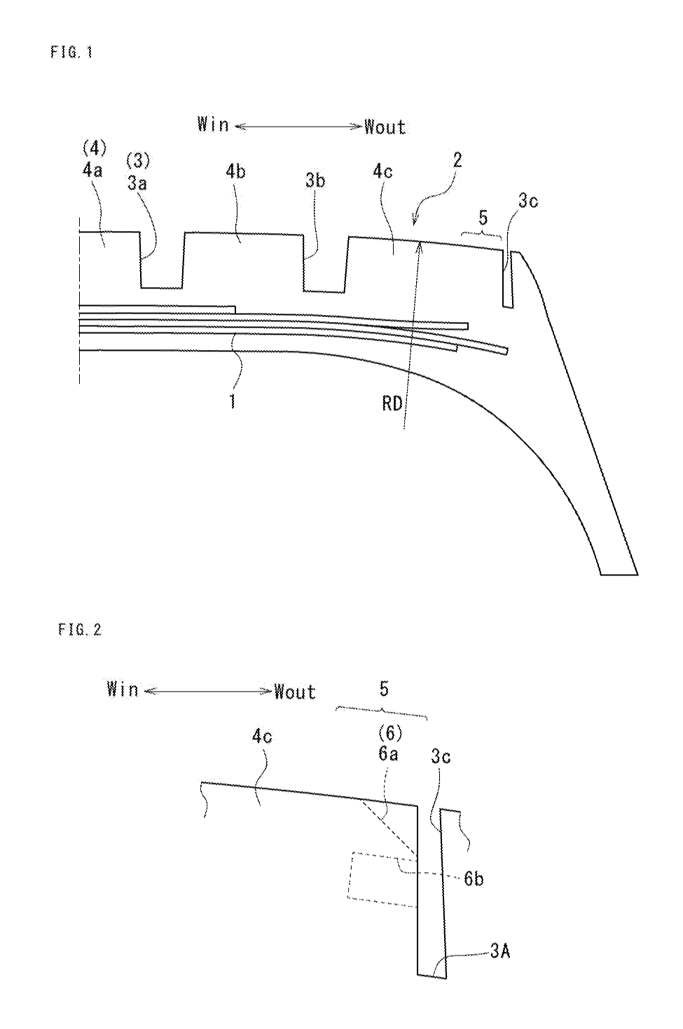

FIG. 1 shows a meridian sectional view of a part of a pneumatic tire according to the present embodiment. In this pneumatic tire, a plurality of belts 1 are wound around the outside in the tire radial direction of the carcass ply (not shown), and a tread portion 2 is provided further on the outer diameter side thereof. In the tread portion 2, a plurality of main grooves 3 extending in the tire circumferential direction CD are formed. A plurality of ribs 4 connected to each other in the tire circumferential direction CD are formed by these main grooves 3.

The rib 4 includes a center rib 4a including the center in the tire width direction, a mediate rib 4b formed between the first main groove 3a and the second main groove 3b on both sides of the center rib 4a, and a shoulder rib 4c formed between the second main groove 3b and the third main groove 3c further on the outer side in the tire width direction of the mediate rib 4b.

In the shoulder rib 4c, a plurality of sipes 6 are formed in the edge region 5 on the rib end side. Here, the rib end side means an outer side in the tire width direction of the shoulder rib 4c, and the edge region 5 means a region where the ground contact pressure becomes the largest when the shoulder rib 4c is grounded.

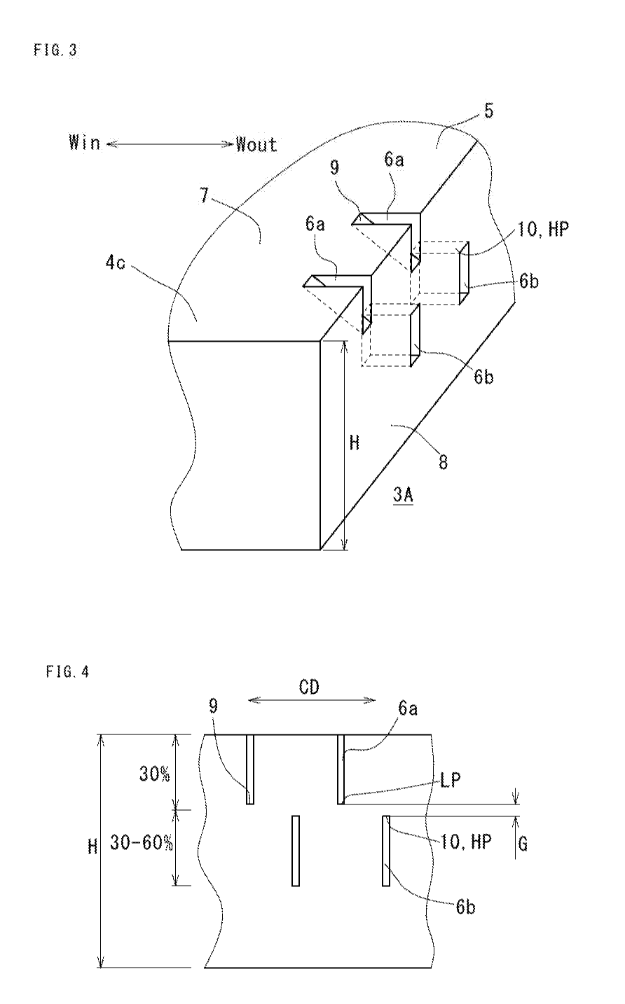

As shown in FIGS. 2 to 4, the sipe 6 includes a first sipe 6a formed on the outer side in the tire radial direction of the shoulder rib 4c and a second sipe 6b formed on the inner side in the tire radial direction. Both the first sipe 6a and the second sipe 6b are formed at equal intervals in the tire circumferential direction CD. Thus, the rigidity on the rib end side of the shoulder rib 4c in the tire circumferential direction CD becomes uniform.

The first sipe 6a opens to a top surface 7 and an outer side surface 8 of the shoulder rib 4c, and a bottom portion 9 is inclined outward in the tire radial direction from the outer side surface 8 toward the inner side in the tire width direction. In other words, the first sipe 6a has a meridian sectional shape of a triangle. In addition, the first sipe 6a is formed in the range of 30% or less of the height dimension H in the tire radial direction from the groove bottom of the main groove 3 of the shoulder rib 4c from the top surface 7 of the shoulder rib 4c toward the inner side in the tire radial direction Win. The depth, shape, spacing, and the like of the first sipe 6a only have to be designed so that the rigidity in the edge region 5 comes close to (if possible, becomes substantially equal to) the rigidity of the other part of the shoulder rib 4c. This allows the wear of the shoulder rib 4c to be made uniform as a whole. In other words, it is possible to have a shoulder rib 4c excellent in uneven wear resistance.

The second sipe 6b opens to the outer side surface 8 of the shoulder rib 4c and extends toward the inner side in the tire width direction with the shape of its opening kept. In other words, the second sipe 6b has a meridian sectional shape of a quadrangle. In addition, the second sipe 6b is formed in the range of 30% or more and 60% or less of the height dimension H in the tire radial direction from a groove bottom 3A of the main groove 3 of the shoulder rib 4c from the top surface 7 of the shoulder rib 4c toward the inner side in the tire radial direction Win. The depth, shape, spacing, and the like of the second sipe 6b only have to be designed so that the rigidity in a state where wear progresses in the edge region 5 and the second sipe 6b opens to the top surface 7 side comes close to (if possible, becomes substantially equal to) the rigidity of the other part of the shoulder rib 4c. Thus, even after the shoulder rib 4c wears beyond the first sipe 6a, the shoulder rib 4c can be caused to wear uniformly as a whole. In other words, it is possible to have a shoulder rib excellent in uneven wear resistance at the middle stage and the latter stage of wear.

The first sipe 6a and the second sipe 6b are disposed so as to have a predetermined space in a tire radial direction RD. That is, in the tire radial direction RD, the range in which the first sipe 6a is formed and the range in which the second sipe 6b is formed are designed not to overlap with each other. Thus, a space G of a predetermined dimension in the tire radial direction is formed between the portion positioned on the innermost side in the tire radial direction (the lowest portion LP) of the bottom portion 9 of the first sipe 6a and the portion where a top portion 10 of the second sipe 6b is positioned (the highest portion HP). Therefore, even if the shoulder rib 4c wears out, the second sipe 6b will not open to the top surface 7 as long as the wear is within the formation range of the first sipe 6a. Therefore, the rigidity in the edge region 5 of the shoulder rib 4c is not largely changed.

The action of the pneumatic tire having the above configuration will be described.

That is, mounting the pneumatic tire on a vehicle and running on the road surface wear the top surface 7 of the tread portion 2. In the edge region 5 on the rib end side of the shoulder rib 4c, its rigidity is weakened by the first sipe 6a. Therefore, the ground contact pressure in the edge region 5 does not increase so much, and the wear amount is suppressed. Thus, the wear amount in the edge region 5 and the wear amount in other portions of the shoulder rib 4c are substantially the same, so that uneven wear is less likely to occur. In addition, the first sipe 6a is formed in a triangular shape in meridian section, and the shoulder rib 4c is constituted so that its rigidity gradually decreases toward the rib end side. Conversely, the rigidity of the shoulder rib 4c is gradually increased toward the inner side in the tire width direction. Therefore, cracks are less likely to occur from the first sipe 6a caused by the ground contact pressure acting during grounding.

If the top surface 7 of the tread portion 2 wears beyond the initial stage where the wear remains within the formation range of the first sipe 6a, the wear reaches the region where the sipe 6 is not formed. Therefore, the first sipe 6a and the second sipe 6b do not open simultaneously in the edge region 5. Therefore, the rigidity of the shoulder rib 4c does not change significantly from the initial stage of wear.

When the top surface 7 of the tread portion 2 further wears and reaches an initial stage, a middle stage, and then a late stage, the second sipe 6b opens to the top surface 7. The second sipe 6b is formed so that the meridian section has a quadrangular shape. Generally, in the shoulder rib 4c, what is called a diameter difference occurs. The diameter difference means that the tire on the rib end side rolls on the road surface slower than the tire on the center side rolls and that the distance traveled while the tire makes one revolution is shorter on the rib end side than on the center side. Therefore, slippage occurs in the tire circumferential direction on the rib end side, but forming the second sipe 6b can suppress this slippage. As a result, it is possible to delay the progress of uneven wear in the shoulder rib 4c.

Thus, according to the embodiment, in the initial stage when the shoulder rib 4c wears, the rigidity on the rib end side of the shoulder rib 4c, that is, in the edge region 5 can be weakened by the first sipe 6a and the occurrence of uneven wear can be delayed. Then, in the middle stage of wear, the second sipe 6b can weaken the slippage in the tire circumferential direction and delay the progress of the uneven wear. Thus, it is possible to lengthen the period of time until the uneven wear of the edge region 5 occurs and progresses. In particular, the first sipe 6a is formed in a triangular shape in meridian section. Therefore, cracks are less likely to occur due to the ground contact pressure. If cracks occur in the initial stage, the wear state in the middle and late stages will be further deteriorated, but such troubles are less likely to be reached. In addition, in the middle and late stages, since the slippage in the tire circumferential direction is further weakened by the second sipe 6b having a quadrangular shape in meridian section, the wear amount can be sufficiently suppressed.

### EXAMPLES

In Comparative Example 1, only the first sipe 6a is formed. In Comparative Example 2, only the second sipe 6b is formed. In Comparative Examples 1 and 2, the meridian sectional shape of the sipe 6 is a quadrangle. In Example 1, the first sipe 6a and the second sipe 6b are formed, and both of the meridian sectional shapes are quadrangular. In Example 2, the first sipe 6a and the second sipe 6b are formed, and both of the meridian sectional shapes are triangular. In Example 3, the first sipe 6a and the second sipe 6b are formed, and the meridian sectional shape of the first sipe 6a is triangular, and the meridian sectional shape of the second sipe 6b is quadrangular. It should be noted that in any of the comparative examples and the examples, the groove depth (the height of the shoulder rib) is 14.6 mm, and the sipe depth is 4.4 mm.

The wear resistance test and the crack resistance test were performed with each pneumatic tire having the above configuration as follows and the performance thereof was evaluated.

Evaluation conditions of the wear resistance test were as follows: assembling a pneumatic tire having a tire size of 295/75R22.5 to a wheel having a rim size of 22.5×8.25 at an air pressure of 760 kPa (TRA standard internal pressure), and traveling at a speed of 80 km/h with a load of 27.5 kN (TRA 100% load).

The evaluation method of the wear resistance test included: comparing the wear amount CW at the center rib 4a and the wear amount SW at the shoulder rib 4c, if the wear amount is uniform (SW=CW), then determining the index as 1.0, if the wear amount of the shoulder rib 4c is larger (SW>CW), then determining the index as a value larger than the index 1.0, and if the wear amount CW of the center rib is larger (SW<CW), then determining the index as a value smaller than the index 1.0. The closer the index is to 1.0, the better the uneven wear resistance.

Evaluation conditions of the crack resistance test were as follows: assembling a pneumatic tire having a tire size of 295/75R22.5 to a wheel having a rim size of 22.5×8.25 at an air pressure of 760 kPa (TRA standard internal pressure), and performing a drum test with a load of 21.8 kN.

The evaluation method of the crack resistance test included: measuring the crack width of the groove bottom after traveling 15000 km, and displaying the index. The larger than 100 the index is, the better the crack resistance is.

TABLE 1

| | COMPARATIVE | COMPARATIVE | | | |
|---|---|---|---|---|---|
| | EXAMPLE 1 | EXAMPLE 2 | EXAMPLE 1 | EXAMPLE 2 | EXAMPLE 3 |
| FIRST SIPE | YES | NO | YES | YES | YES |
| | (QUADRANGLE) | | (QUADRANGLE) | (TRIANGLE) | (TRIANGLE) |
| SECOND SIPE | NO | YES | YES | YES | YES |
| | | (QUADRANGLE) | (QUADRANGLE) | (TRIANGLE) | (QUADRANGLE) |
| UNEVEN WEAR | 1.5 | 1.5 | 1.2 | 1.1 | 1.0 |
| RESISTANCE | | | | | |
| CRACK | 100 | 105 | 108 | 110 | 110 |
| RESISTANCE | | | | | |

As is clear from Table 1, providing the first sipe 6a and the second sipe 6b allowed excellent results to be obtained in any of the uneven wear resistance and the crack resistance. Setting the meridian sectional shape of the sipe 6 as a triangle allowed these values to be further improved. In particular, setting the meridian sectional shape of the first sipe 6a as a triangle and the second sipe 6b as a quadrangle allowed even better results to be obtained in uneven wear resistance.

It should be noted that the present invention is not limited to the configuration described in the above embodiment, and various modifications are possible.

In the above embodiment, the bottom portion 9 of the sipe 6 is formed by a flat inclined surface or a horizontal surface substantially parallel to the top surface, but the present invention is not limited thereto and the bottom portion 9 may be formed by a curved surface. In this case, the curved surface may have a recessed shape or a shape bulging in the sipe 6.

In the above embodiment, the meridian sectional shapes of the first sipe 6a and the second sipe 6b are described with the examples of triangular and quadrangular, both quadrangular, and both triangular, but it is also possible to make the first sipe 6a quadrangular and the second sipe triangular. However, in order to prevent occurrence of cracks in the initial stage, the meridian sectional shape of the first sipe 6a is preferably triangular.

What is claimed is:

1. A pneumatic tire comprising a plurality of ribs formed by a plurality of main grooves extending in a tire circumferential direction, the plurality of ribs connected to each other in the tire circumferential direction, wherein a shoulder rib positioned on either side in a tire width direction of the ribs includes: a first sipe configured to open to a ground contact surface and an outer side surface on a rib end side, and a second sipe positioned on an inner side in a tire radial direction of the first sipe, the second sipe configured to open to the outer side surface.

2. The pneumatic tire according to claim 1, wherein the first sipe and the second sipe are arranged at equal intervals in a tire circumferential direction.

3. The pneumatic tire according to claim 1, wherein the first sipe and the second sipe are arranged to be displaced in a tire circumferential direction.

4. The pneumatic tire according to claim 2, wherein the first sipe and the second sipe are arranged to be displaced in a tire circumferential direction.

5. The pneumatic tire according to claim 1, wherein the first sipe has a triangular shape in meridian section in which a bottom portion is inclined outward in a tire radial direction toward an inner side in a tire width direction.

6. The pneumatic tire according to claim 2, wherein the first sipe has a triangular shape in meridian section in which a bottom portion is inclined outward in a tire radial direction toward an inner side in a tire width direction.

7. The pneumatic tire according to claim 3, wherein the first sipe has a triangular shape in meridian section in which a bottom portion is inclined outward in a tire radial direction toward an inner side in a tire width direction.

8. The pneumatic tire according to claim 1, wherein the second sipe has a quadrangular shape in meridian section in which a bottom portion does not change a position in a tire radial direction toward an inner side in a tire width direction.

9. The pneumatic tire according to claim 2, wherein the second sipe has a quadrangular shape in meridian section in which a bottom portion does not change a position in a tire radial direction toward an inner side in a tire width direction.

10. The pneumatic tire according to claim 3, wherein the second sipe has a quadrangular shape in meridian section in which a bottom portion does not change a position in a tire radial direction toward an inner side in a tire width direction.

11. The pneumatic tire according to claim 1, wherein the first sipe is provided in a range of 30% or less of a height dimension from the main groove of the shoulder rib from a top surface of the shoulder rib.

12. The pneumatic tire according to claim 2, wherein the first sipe is provided in a range of 30% or less of a height dimension from the main groove of the shoulder rib from a top surface of the shoulder rib.

13. The pneumatic tire according to claim 3, wherein the first sipe is provided in a range of 30% or less of a height dimension from the main groove of the shoulder rib from a top surface of the shoulder rib.

14. The pneumatic tire according to claim 1, wherein the second sipe is provided in a range of 30% or more and 60% or less of a height dimension from the main groove of the shoulder rib from a top surface of the shoulder rib.

15. The pneumatic tire according to claim 2, wherein the second sipe is provided in a range of 30% or more and 60% or less of a height dimension from the main groove of the shoulder rib from a top surface of the shoulder rib.

16. The pneumatic tire according to claim 3, wherein the second sipe is provided in a range of 30% or more and 60% or less of a height dimension from the main groove of the shoulder rib from a top surface of the shoulder rib.

17. The pneumatic tire according to claim 1, wherein a bottom portion of the first sipe and a top portion of the second sipe have a predetermined space in between in a tire radial direction.

18. The pneumatic tire according to claim 2, wherein a bottom portion of the first sipe and a top portion of the second sipe have a predetermined space in between in a tire radial direction.

19. The pneumatic tire according to claim 3, wherein a bottom portion of the first sipe and a top portion of the second sipe have a predetermined space in between in a tire radial direction.
